(19) United States
(12) Patent Application Publication
(10) Pub. No.: US 2005/0052121 A1
(43) Pub. Date: Mar. 10, 2005

(54) Electroluminescent material

(75) Inventor: Seiji Yamashita, Minami-ashigara-shi (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 10/935,439

(22) Filed: Sep. 8, 2004

(30) Foreign Application Priority Data
Sep. 8, 2003 (JP) 2003-315431

(51) Int. Cl. H05B 33/14; H05B 33/26

(52) U.S. Cl. 313/503; 313/498

(57) ABSTRACT

A semiconductor particle, which is formed by baking, at a temperature of from 500° C. to 1,500° C., a particle formed by a liquid phase method and having an average equivalent sphere diameter of primary particle of 0.15 μm or more; a phosphor particle, which contains, as a base material, the semiconductor particle; and an electroluminescent device, which has a light-emitting layer containing the phosphor particle, a dielectric layer, and a pair of electrodes sandwiching the light-emitting layer and the dielectric layer between the electrodes.

### FIELD OF THE INVENTION

The present invention relates to an electroluminescent material. Further, the present invention relates to a semiconductor particle that can be used in applications of electroluminescence with enhanced luminance and luminous efficiency, and also to a phosphor particle. Further, the present invention relates to an electroluminescent device using the particle.

### BACKGROUND OF THE INVENTION

Electroluminescent devices are divided broadly into dispersion-type electroluminescent devices, in which phosphor particles are dispersed in a high-dielectric substance, and thin film-type electroluminescent devices, having a phosphor thin film sandwiched between dielectric layers.

In AC drive-type electroluminescent materials, those having a structure of a dispersion-type electroluminescent device are relatively easily made into a large area. For this advantage, development of plane-type light emission sources using these materials has progressed. As diversification of various electronic machinery and tools has advanced in recent years, these materials have also been applied to display materials for decoration, in addition to display devices of electronic machinery and tools.

In the dispersion-type electroluminescent device, a luminescence (light-emitting) layer, comprising a phosphor particle contained in a high-dielectricity polymer, such as a fluorine-containing rubber or a polymer having a cyano group, is arranged between a pair of electrically conductive electrode sheets, at least one of which is light-transmissible. In an ordinary form of the particle-dispersion type, a dielectric layer is arranged, to prevent dielectric breakdown. The dielectric layer comprises a powder of a ferroelectric substance, such as barium titanate, contained in a highly dielectric polymer. The phosphor particle used in this type generally comprises ZnS, as a host material thereof, which is doped with an appropriate amount of ions of Mn, Cu, Cl, Ce or the like. The particle size that the phosphor particle has, is generally 10 to 30 μm.

Since a high-temperature process is not required to produce the particle dispersion type, the dispersion-type electroluminescent device has following advantageous characteristics: A flexible device (material structure) having a plastic as a substrate can be produced; the type can be produced at low costs through relatively simple steps without using a vacuum machine; and the luminous color of the device can easily be adjusted by mixing a plurality of kinds of phosphor particles that give different luminous colors. Thus, this type is applied to back lights in LEDs and the like, and display devices. However, the light-emission luminance thereof is low. As a result, the scope to which the dispersion-type electroluminescent device can be applied is restricted, and it is therefore desired to improve the light-emission luminance and the luminous efficiency further.

Hitherto, to enhance luminance of the dispersion-type electroluminescent device, various attempts related to the formation of phosphor particles have been made. For example, JP-A-6-306355 (“JP-A” means unexamined published Japanese patent application) describes that two baking steps, and means of applying impact to particles in the interval of the baking steps, are effective to enhance luminance.

JP-A-3-086785 and JP-A-3-086786 each describe that luminance can be enhanced, by baking, under an atmosphere of hydrogen sulfide and hydrochloric acid.

JP-A-2002-322469, JP-A-2002-322470, and JP-A-2002-322472 describe methods of forming homogeneous phosphor particles, by spraying a gaseous dissolved salt, and causing heat decomposition/reaction, to form particles.

However, these methods fail to realize controlled particle formation including homogeneous nucleation and subsequent growth steps. As a result, phosphor particles exhibiting electroluminescence with high luminance and good luminous efficiency are not yet available.

### SUMMARY OF THE INVENTION

The present invention resides in a semiconductor particle, which is formed by baking, at a temperature of from 500° C. to 1,500° C., a particle formed by a liquid phase method and having an average equivalent sphere diameter of primary particle of 0.15 μm or more.

Further, the present invention resides in a phosphor particle, which contains, as a base material, the semiconductor particle described above.

Further, the present invention resides in an electroluminescent device, which comprises:
a light-emitting layer containing the phosphor particle described above;
a dielectric layer; and
a pair of electrodes sandwiching the light-emitting layer and the dielectric layer between the electrodes.

Other and further features and advantages of the invention will appear more fully from the following description.

### DETAILED DESCRIPTION OF THE INVENTION

According to the present invention, there are provided the following means:
(1) A semiconductor particle, which is formed by baking, at a temperature of from 500° C. to 1,500° C., a particle formed by a liquid phase method and having an average equivalent sphere diameter of primary particle of 0.15 μm or more;
(2) The semiconductor particle according to the above item (1), wherein, during the baking step, a mixture of the particle (acting as a seed particle) formed by the liquid phase method, and a raw particle having an average equivalent sphere diameter of primary particle of 0.10 μm or less, is baked, to grow the seed particle;
(3) The semiconductor particle according to the above item (1) or (2), wherein the particle is formed by dividing the baking step into a first baking and a second baking, in which the second baking is carried out at a temperature lower than the first baking;
(4) The semiconductor particle according to any one of the above items (1) to (3), wherein the semiconductor is a II-VI group or III-V group compound;
(5) The semiconductor particle according to any one of the above items (1) to (3), wherein the semiconductor is zinc sulfide;
(6) The semiconductor particle according to any one of the above items (1) to (5), wherein a coefficient of deviation of the formed particle is 30% or less, in terms of equivalent sphere diameter;
(7) A phosphor particle, containing, as a base (host) material, the semiconductor particle according to any one of the above items (1) to (6); and
(8) An electroluminescent device, comprising:
   a light-emitting layer containing the phosphor particle according to the above item (7);
   a dielectric layer; and
   a pair of electrodes sandwiching the light-emitting layer and the dielectric layer between the electrodes.

Herein, the term “equivalent sphere diameter” means a diameter of a sphere whose volume is equal to that of an individual particle. Further, the term “average equivalent sphere diameter” means an arithmetic mean of the equivalent sphere diameters of individual particles measured.

The present invention is described in detail below.

The host material of phosphor particles, which can be preferably used in the present invention, is specifically a semiconductor particle that is composed of one or more selected from the group consisting of elements of the II group, elements of the III group and elements of the IV group, and/or one or more selected from the group consisting of elements of the V group and elements of the VI group, and these elements may be selected at will in accordance with a required luminescence wavelength region. Herein, the II to VI groups are those in the periodic table of elements. As the semiconductor, II-VI group or III-V group compound semiconductors are preferable. Examples of these compounds include CdS, CdSe, CdTe, ZnS, ZnSe, ZnTe, CaS, MgS, SrS, GaP, GaAS, and mixed crystals of these compounds. In particular, ZnS, CdS and CaS can be preferably used.

In addition to the above, as a host material of the phosphor particles, BaAl₂S₄, CaGa₂S₄, Ga₂O₃, Zn₂SiO₄, Zn₂GaO₄, ZnGa₂O₄, ZnGeO₃, ZnGeO₄, ZnAl₂O₄, CaGa₂O₄, CaGeO₃, Ca₂Ge₂O₇, CaO, Ga₂O₃, GeO₂, SrAl₂O₄, SrGa₂O₄, SrP₂O₇, MgGa₂O₄, Mg₂GeO₄, MgGeO₃, BaAl₂O₄, Ga₂Ge₂O₇, BeGa₂O₄, Y₂SiO₅, Y₂GeO₅, Y₂Ge₂O₇, Y₄GeO₈, Y₂O₃, Y₂O₂S, SnO₂, or mixed crystals thereof, can be preferable used.

As the luminescence center, ions of metal such as Mn and Cr, and rare earth elements such as Eu and Tb, can be preferably used.

In the present invention, the semiconductor particles are those formed by baking, at a temperature of from 500° C. to 1,500° C., particles formed by a liquid phase method, in which an average equivalent sphere diameter of primary particles of the particles formed by the liquid phase method is 0.15 μm or more. As the liquid phase method, a hydrothermal method is preferable. Taking zinc sulfide as an example of the semiconductor, ZnS crystals have extremely low solubility to water. Such property is indeed very disadvantage to a method of growing particles upon the ionic reaction in an aqueous solution. A solubility of ZnS crystals to water increases as a temperature of water is elevated. However, water turns a supercritical state at 375° C. or more. In the supercritical state, a solubility of ions extremely reduces. Accordingly, a temperature for preparing particles is preferably a room temperature or more but not more than 375° C., more preferably in the range of from 200° C. to 350° C. A time to be spent for preparing particles is preferably within 100 hours, more preferably within 12 hours, but 5 minutes or more.

It is also preferable to use a chelating agent in the present invention, as another method of increasing the solubility of zinc sulfide in water. As a chelating agent of Zn ion, those having an amino group and/or a carboxyl group are preferable. Specific examples of the chelating agent include ethylenediaminetetraacetic acid (hereinafter referred to as EDTA), N,2-hydroxyethylethylenediaminetriacetic acid (hereinafter referred to as EDTA-OH), diethylenetriaminepentaacetic acid, 2-aminoethylethylene-glycol-tetraacetic acid, 1,3-diamino-2-hydroxypropanetetraacetic acid, nitrilotriacetic acid, 2-hydroxyethyliminodiacetic acid, iminodiacetic acid, 2-hydroxyethylglycine, ammonia, methylamine, ethylamine, propylamine, diethylamine, diethylenetriamine, triaminotriethylamine, allylamine, and ethanolamine. The employment of such a chelating agent is not restricted to ZnS, but a common idea.

When particles are prepared by direct precipitation reaction of a constituting metal ion with a chalcogen anion, without using any precursor of the constituting elements, rapid mixing of solutions of the two is necessary. It is preferable to use a mixer of a double-jet type.

If any of these methods is freely used, nucleation and growth may be separated in the liquid phase method. In many cases, after having formed mono-dispersed nuclei using a flash mixing method in combination with Ostwald ripening, growth is carried out in the neighborhood of the supercritical growth rate, so that mono-dispersed particles in terms of size and/or shape can be obtained.

The thus-grown particles are typically of the order of from μm to sub-μm in size. However, very homogeneous particles having a high degree of mono-dispersion can be obtained. In order to grow these particles into larger sized ones, or to form, inside a particle, a dopant such as a luminescence center to need diffusion at a high temperature, it is very effective that after having formed particles according to a liquid phase method, a baking method is used in combination with the liquid phase method.

In the present invention, an average equivalent sphere diameter of primary particles grown according to a liquid phase method is 0.15 μm or more. If the average equivalent sphere diameter is too small, there is a possibility that particles fuse at the subsequent baking step so that it becomes difficult to make the best use of characteristics of the original particles. The average equivalent sphere diameter is preferably 0.3 μm or more, especially preferably in the range of from 0.5 to 15 μm.

The baking temperature is in the range of from 500° C. to 1,500° C., preferably in the range of from 500° C. to 1,350° C., more preferably in the range of from 500° C. to 1,200° C. If the baking temperature is too low, particles may grow into large sized ones according to the liquid phase method alone, and therefore such low baking temperature lessens a meaning of using the liquid phase method in combination with a baking method. On the other hand, if the baking temperature is too high, characteristics of the seed particles sometimes changes too largely owing to dissolution and the like, similar to the case of small sized particles of less than 0.15 μm.

At the time of baking, for growth of seed particles, use can be preferably made of raw particles much smaller than the seed particles, namely raw particles whose primary particles have an average equivalent sphere diameter of 0.10 μm or less.

Further, use can be preferably made of a method of carrying out two or more multistage baking, separating a step of growing particles by a high-temperature baking and a step of doping an activating-agent by a low-temperature baking. This method is widely used in the field of the art. In the case of two-stage baking, the first baking is carried out at a temperature of preferably in the range of from 500° C. to 1,500° C., more preferably in the range of from 900° C. to 1,300° C. The second baking subsequent to the first baking is carried out at a temperature of preferably in the range of from 150° C. to 900° C., more preferably in the range of from 300° C. to 800° C. The second baking is preferably carried out at a temperature lower than that in the first baking.

As described above, homogenization in activation of a luminescence center and formation of homogeneous large-sized particles have been realized, by a method of using semiconductor particles of mono-dispersion in terms of size and/or shape as a base material, and activating a luminescence center on the particles, and further growing the particles.

As a result, there is no distribution in luminance and luminous efficiency among particles. Thereby electroluminescent phosphors having high luminance and high luminous efficiency can be obtained.

The size of the semiconductor particle after baking changes depending on materials to be used, conditions for baking, or the like. In the present invention, the particle diameter of the semiconductor particle after baking is preferably in the range of from 0.15 μm to 30 μm, more preferably from 0.3 μm to 15 μm, and further preferably from 0.5 μm to 10 μm.

The particle size distribution of the semiconductor particles of the present invention is preferably 30% or less. The term “particle size” herein used means an equivalent sphere diameter of the particle. The term “particle size distribution” herein used means a coefficient of variation relative to the equivalent sphere diameters of the particles.

The narrower the particle size distribution is, the better the luminous property is. The particle size distribution is more preferably 20% or less.

In the case that the particle size distribution is too broad, if phosphor particles composed of such broad distribution particles as a base material are used for electroluminescent devices, a film thickness of the light-emitting layer is hardly unified and a scattering in luminous properties arises among phosphor particles under the influence of the broad distribution. For this reason, the resulting devices exert a very slow build up of luminescence to an applied voltage. As a result, a high voltage and a large power are needed to obtain a high luminance.

The light-emitting layer in the electroluminescent device of the present invention can be formed according to a usual manner, for example, by a coating method described below, using any material such as a binder, except for using the aforementioned specific phosphor particle of the present invention. The thickness of the light-emitting layer is not particularly limited and may be set at a usual thickness in a conventional device.

To form a particle dispersion-type thin electroluminescent device according to the present invention, materials of the dielectric layer are important. In the present invention, a dielectric constant of the dielectric layer is preferably 100 or more. If the dielectric constant is too low, it is sometimes that effective (active) electric field cannot be applied to the light-emitting layer, which results in lowering of the luminance.

Besides, if a high voltage is applied to enhance the luminance, dielectric breakdown may be apt to occur, so that it becomes particularly difficult to make the electroluminescent device into a large area that is easily affected by fluctuation of its thickness.

A dielectric constant of the dielectric layer for use in the present invention is preferably 100 or more, particularly preferably 200 or more. It is preferable that the dielectric constant is as high as possible. Factually, however, when a high permittivity is required, a dielectric layer is baked and large size dielectric particles are used in response to such requirement. A high-temperature baking makes it difficult to use flexible materials composed of organic substances such as polyethylene terephthalate. To make the dielectric particles into a large size results in loss of uniformity and smoothness of the dielectric layer. Thereby, troubles such as dielectric breakdown under applied voltage may occur.

The dielectric material to be used in the dielectric layer according to the present invention, may be made of any material that has a high dielectric constant, a high insulating property, and a high dielectric breakdown voltage. This material can be selected from metal oxides and nitrides. For example, any of the followings can be used: BaTiO₃, KNbO₃, BaTiO₃, LiNbO₃, LiTaO₃, Ta₂O₃, BaTa₂O₆, Y₂O₃, Al₂O₃, and AlON. Employment of these materials in the form of a film having a particle structure rather than uniformity enables material formation to be carried out by coating. For example, use can be made of a film composed of BaTiO₃ fine particles and BaTiO₃ sol, as described in Mat. Res. Bull., Vol. 36, p. 1065.

In general, though it depends on the dielectric constant of the film, the thickness of the film is preferably made as thin as possible, as long as dielectric breakdown, or dielectric breakdown at a defective portion of the film due to an alien substance, or the like, is not caused. This is because voltage applied to the light-emitting layer (phosphor layer) can be made large. Considering this matter, the thickness is appropriately selected in accordance with structure of the film or the preparation process thereof.

The light-emitting layer and the dielectric layer are preferably provided by coating according to, for example, a spin coating method, a dip coating method, a bar coating method, and a spray coating method. Particularly, it is preferable to use a method having a great variety of subjects to be printed such as a screen-printing method or a method of enabling continuous coating such as a slide coating method. For example, the screen-printing method is to coat, through a screen mesh, a dispersion of phosphor or dielectric fine-particles dispersed in a high permittivity polymer solution. A film thickness can be controlled properly regulating thickness and/or numerical aperture of the screen mesh, and also selecting number of times in coating. Changing the dispersion to another one makes it possible to form not only a light-emitting layer and a dielectric layer, but also a backing electrode layer, and the like. In addition, to make into a large area can be easily attained by altering a screen size.

A most preferable film thickness of the dielectric layer for use in the present invention is in the range of from 0.5 μm to 50 μm. If the film thickness is too thin, it becomes difficult to form a uniform film by coating. As a result, it becomes difficult to form a material capable of giving uniform emission over a large area. On the other hand, if the film thickness is too thick, not only the material becomes thick, but also the voltage applied to a phosphor layer decreases. As a result, in order to obtain a high luminance, high voltage to be applied and much energy consumption are needed.

Further, a film can be produced by a method of coating a dispersion or sol of dielectric fine-particles, and thereafter sintering the coating by such means of an electric furnace, an infrared lamp or a microwave. When ferroelectric fine-particles are used, a size of the ferroelectric particles to be used is preferably in the range of from 10 nm to 500 nm.

In order to provide a thin light-emitting layer adjacently on the dielectric layer, it is necessary that the light-emitting layer side surface of the dielectric layer has sufficient smoothness. For this purpose, in the case of the film made of dielectric particles, it is preferable to make this film surface smooth, for example, by providing a second dielectric layer having good smoothness, as described in U.S. Pat. No. 5,432,015, or by filling gaps among BaTiO₃ particles with BaTiO₃ sol, as described in Mat. Res. Bull., Vol. 36, p. 1065.

A typical electroluminescent device of the present invention is provided with a light-emitting layer containing the aforementioned phosphor particles, a dielectric layer, and a pair of electrodes sandwiching the light-emitting layer and the dielectric layer between the electrodes. However, if necessary, an additional layer may be provided on the device of the present invention. For example, to prevent dielectric breakdown owing to pinhole or the like, or to prevent undesirable transferring of the constituting elements between the dielectric layer and the light-emitting layer, a thin film such as a silicon oxide film or an aluminum oxide film can be preferably provided adjacent to the light-emitting layer. Further, to inject electrons effectively into the light-emitting layer, an injection layer such as a yttrium oxide thin film or a hafnium oxide thin film may be preferably provided adjacent to the light-emitting layer.

The electrically conductive substrate that can be used in the present invention may be a substrate having electrical conductivity by itself, or a non-electrically conductive substrate having thereon an electrically conductive electrode layer. As the substrate, there is no particular restriction, so long as it has a requisite physical strength, resistance to heat, and flatness. Generally, metal, glass or ceramic materials are used. Preferable examples of the substrate include those made of alumina or zirconia.

In ordinary embodiments of the present invention, the device at least comprises a dielectric layer, a light-emitting layer, and a pair of electrodes which sandwiches these layers, and at least one of the electrodes is a transparent electrode. As the transparent electrode used for this purpose, generally used transparent electrode materials are arbitrarily used. Examples of the transparent electrode material include oxides such as tin-doped tin oxide, antimony-doped tin oxide, and zinc-doped tin oxide; multi-layer structure films of silver thin film sandwiched between high-refractive-index layers; and π-conjugated polymers, such as polyanilines and polypyrroles.

It is also preferable to arrange a tandem-type, grid-type, or the like type metal fine line on the transparent electrode, thereby to improve current-carrying performance.

The back electrode, which is present on the side from which light is not taken out, may be made of any material that has electric conductivity. The material is appropriately selected from metals such as gold, silver, platinum, copper, iron and aluminum; graphite, and other materials, considering the form of the device to be produced, the temperature in producing steps, and other factors.

The device of the present invention may have a device structure wherein a transparent electrode layer, a light-emitting layer, a dielectric layer, and a back electrode are successively arranged on a transparent substrate, thereby taking out light from the side of the substrate; or a device structure wherein an electrode layer, a dielectric layer, a light-emitting layer and a transparent electrode layer are successively arranged on a light non-transmissible substrate, thereby taking out light from the side opposite to the substrate. A structure wherein dielectric layers are arranged on both sides of a light-emitting layer may be employed for stable operation. In this case, however, it is necessary that the dielectric layer on the side from which light is taken out has sufficient light transmissibility. Further, if necessary, light can be taken out from an edge portion of the material. In this case, the two electrodes are made of a light reflective material.

The light-emitting device of the present invention is generally worked, at end of its production, with a suitable sealing material, so as to exclude effect of humidity from external environment. In the case that the substrate itself of the device has sufficient shielding property, a shielding sheet (to seal, for example, moisture or oxygen) may be put over the produced device and the surrounding of the device may be sealed with a hardening material such as epoxy resin.

The material for the above shielding sheet may be selected from glass, metal, plastic film, or the like, according to the application.

The materials and devices of the present invention are not particularly restricted in their application. However, taking the application as a light source into consideration, preferably the luminescent color is a white color.

As the method of outputting a white luminescent color, use can be preferably made, for example, of a method of using phosphor particles capable of self-emitting a white light such as zinc sulfide phosphor activated with copper and manganese and gradually cooled after baking, or a method of mixing two or more kinds of phosphors capable of emitting three primary colors or complementary colors from each other. For example, a combination of blue, green and red, and a combination of bluish green and orange may be used, to obtain a white light. It is also preferable to use a method of making into a white color according to the steps of emitting a short-wavelength light such as blue, and then using a fluorescent pigment or a fluorescent dye, thereby to wavelength-convert (emit) a part of the emission to green and red, as described in JP-A-7-166161, JP-A-9-245511 and JP-A-2002-62530. Further, as CIE chromaticity coordinates (x, y), it is preferable that the value x is in the range of 0.30 to 0.43 and the value y is in the range of 0.27 to 0.41.

Further, in the constitution of the device of the present invention, a substrate, a transparent electrode, a back electrode, any of various protective layers, a filter, a light-scattering reflecting layer, and the like may be provided, if necessary. As the substrate in particular, a flexible transparent resin sheet may also be used, in addition to a glass substrate or a ceramic substrate.

The phosphor particle of the present invention is excellent in luminance properties. Further, according to the present invention, a thin electroluminescent device of AC drive-type, which can be made into a large area, can be provided. Further, a thin and lightweight electroluminescent device having a simple device structure and excellent flexibility can be obtained.

The present invention will be explained in more detail by way of the following examples, but the invention is not intended to be limited thereto.

### EXAMPLES

### Example 1

1) Preparation of Particles

To a closed-type reaction vessel heated to 300° C., an aqueous solution containing 6 moles of sodium sulfide, and an aqueous solution containing 6 moles of zinc nitrate, were added over 5 minutes, at an addition rate of 0.2 moles per minute, following by ripening for 1 hour. Further, each residue of these two aqueous solutions was added, over 4 hours. At that time, 0.6 moles of sodium sulfide, and one liter of a solution containing 0.6 moles of sodium chloride, were provided in advance in the reaction vessel, and the pH of the solution was adjusted to 3 or less, using sulfuric acid. Additionally, a copper sulfate solution was added, in a quantitative proportion of 0.1 mole % based on zinc. The above particle preparation resulted in zinc sulfide particles having an average particle diameter of 1 μm, a coefficient of deviation of 15%, and a zinc blende structure of about 90%. To the particles, a raw material crude powder of zinc sulfide, having a primary particle diameter of 20 nm, was added in a proper quantity under an atmosphere of hydrogen sulfide and nitrogen. Further, MgCl₂, NaCl, and BaCl₂, as a flux, were added thereto in a proper quantity of about 20% by mass to the entire zinc sulfide. After adding thereto, as an activating agent, about 0.1 mole % of copper sulfate; a very small amount of chloroauric acid, and further, a proper quantity of zinc oxide, the resultant mixture was baked at 1,200° C. for 2 hours, in such a manner that the particles would not sintered with each other by baking.

The thus-obtained particles were subjected to sufficient dispersion to separate the aggregated particles into each individual particle while distilled water was added thereto, and then this was followed by ultrasonic dispersion for about 1 hour.

Thereafter, a resulting powder was taken out from the reaction vessel and dried. The powder was pulverized and dispersed using a ball mill. Further, 5 g of ZnCl₂ and copper sulfate in an amount of 0.1 mole % to ZnS were added, and then 1 g of MgCl₂ was added. The dried powder that was prepared as mentioned above was again placed in an alumina crucible, to bake at 700° C. for 2 hours as a second baking. At that time, baking was carried out under an atmosphere generated by flowing 10% hydrogen sulfide gas.

The thus-baked particles were pulverized again, followed by dispersion and sedimentation in H₂O at 40° C., and then washing after decantation. Thereafter, a 10% hydrochloric acid solution was added thereto, for dispersion and sedimentation. After eliminating unnecessary salts by decantation, the resultant particles were dried. Then, the surface of the particles was washed with a 10% KCN solution heated at 60° C., to eliminate Cu ions and the like.

The thus-obtained phosphor particles had an average particle diameter of 7 μm and a coefficient of deviation of 27%. At least 70% of said particles had 10 or more stacking faults per particle.

Those particles are designated as A1. Likewise, particles A2 to A8 were prepared in the same manner as A1, except for changing the temperature of the reaction vessel, the addition rate, and the like.

Separately, to dry powder of 25 g of zinc sulfide (ZnS) particulate powder having an average particle diameter of 20 nm, to which was added copper sulfate in an amount of 0.08 mol % based on ZnS, was added 5 g of ammonium chloride (NH₃Cl) powder as a flux. The resultant dry powder was put into a crucible made of alumina, followed by baking at 1,200° C. for 1.5 hours and then rapid cooling. Thereafter, the powder was taken out, followed by pulverization in a ball mill and dispersion. Thereto were added ZnCl₂ in an amount of 5 g and copper sulfate in an amount of 0.10 mol % based on ZnS. Thereafter, 1 g of MgCl₂ was added thereto, to prepare a dry powder. Again, the powder was put into an alumina crucible and baked at 700° C. for 2 hours. The baking was conducted while 10% hydrogen sulfide gas as an atmosphere was flowed. The particles after the baking were again pulverized, followed by dispersion and sedimentation in H₂O of temperature 40° C. The supernatant was removed by decantation, followed by washing. Thereafter, a 10% solution of hydrochloric acid was added thereto, followed by dispersion and sedimentation. The supernatant was removed and unnecessary salts were removed, followed by drying. Further, the resultant particles were washed with a 10% KCN solution heated to 70° C., to remove Cu ions and others from the surface thereof.

The thus-obtained phosphor particles had an average particle diameter of 10 μm and a coefficient of deviation of 35%. At least 30% of said particles had 10 or more stacking faults per particle.

These particles are designated as B1. Likewise, particles B2 to B3 were prepared in the same manner as B1, except for changing the conditions of baking.

2) Preparation of a Slurry for a Dielectric Layer

To 1,000 mL of ethanol was added 37 g of titanium tetraisopropoxide. While the mixture solution was stirred, thereto was added 500 mL of a 4% ethanol solution of lactic acid. Further, thereto was added 500 mL of an aqueous acetic acid solution containing 51 g of barium acetate, and subsequently the resultant solution was allowed to stand at 60° C. for 5 hours under stirring. To the solution under stirring, was added 150 g of barium titanate fine-particle (primary particle diameter: 100 nm) that had been dispersed in advance in a mixture solution of water and methanol (1:1). While the solution was cooled, it was subjected to treatment with ultrasonic waves for 3 hours, to prepare a homogeneous slurry.

3) Formation of a Dielectric Layer

On a 20-cm square, 200 μm-thick substrate, aluminum was vapor-deposited, to prepare a back electrode. The electrode was coated with the aforementioned slurry according to a screen-printing method, so that the deposited aluminum could be covered with the slurry. In that time, coating was carried out, of 5 μm thickness for each coating. After coating, the product was dried at 120° C., and then the coatings were repeated again and again in the same manner as mentioned above. Finally, a 20 μm-thick dielectric film was formed. The formed film had excellent surface smoothness, and a variation of film thickness of +1.5 μm. Dielectric properties of the film were evaluated using a frequency property analytical instrument FRA 5095 (trade name, manufactured by NF Circuit Design Block Co.). As a result, it was confirmed that a dielectric constant of 120±10 was obtained within the range of from 100 Hz to 1 kHz.

4) Formation of a Light-Emitting (Phosphor) Layer

A proper quantity of any of the particles A1 to A8 and B1 to B3, that were obtained in the aforementioned item 1), was mixed with a 30-mass % solution of a cyano resin dissolved in dimethylformamide, manufactured by Shinetsu Chemical Co., Ltd., to disperse the ZnS particles. Thus, a phosphor layer coating solution was prepared. Using the thus-prepared coating solution, the surface of the dielectric layer prepared in the aforementioned item 3) was coated, followed by drying, to prepare a 15.0 μm-thick light-emitting layer.

5) Formation of an Upper Transparent Electrode

A transparent and electrically conductive ITO film, facing to the back electrode, was formed on the side of the substrate formed thereon the light-emitting layer, and the like, by a sputtering method. The film had a thickness of about 500 nm, and an area resistance of about 20 ohms.

The thus-prepared device was dried at 100° C. for several hours under a nitrogen atmosphere.

6) Sealing

Each electric terminal for the external connection was taken out, using a silver paste, from the aluminum electrode and the transparent electrode of the aforementioned device. Thereafter, the device was sandwiched between two moisture-proof films, and the surroundings thereof was cured with an epoxy resin, to seal. Thereby, electroluminescent devices A1 to A8 according to the present invention, and those B1 to B3 for comparative examples, were obtained, respectively. The operation in the above process was carried out under a nitrogen atmosphere.

7) Measurement of Luminescence Property

A sine-wave signal generator and a powder amplifier were used to apply an alternating-current electric field to any of the thus-prepared luminescent devices, to measure luminescence intensity thereof with a luminance photometer BM9 (trade name) manufactured by Topcon Corp. As driving conditions, a frequency of 1 kHz and a voltage of 200 V were used.

The results are shown in Table 1.

The light-emitting luminance measured for each device is shown, in Table 1, as a relative value, i.e. relative luminance, in which the luminance in the Device A1 be represented by 100.

TABLE 1

| | Particle size* | Particle | Variation | | | Size of | | |
|---|---|---|---|---|---|---|---|---|
| | formed by | size | coefficient | Baking | | raw | | |
| | liquid-phase | after | of sphere | temperature | | particle | | |
| Device | method | baking | equivalent | during baking | | used in | Relative | |
| (Particle) | (μm) | (μm) | diameter (%) | (° C.) | | baking (nm) | luminance | Remarks |
| A1 | 1.0 | 7.0 | 27 | First | 1,200 | 20 | 100 | This invention |
| | | | | Second | 700 | | | |
| A2 | 0.10 | 9.0 | 35 | First | 1,200 | 20 | 30 | Comparative |
| | | | | Second | 700 | | | example |
| A3 | 3.0 | 10.0 | 22 | First | 1,200 | 20 | 200 | This invention |
| | | | | Second | 700 | | | |
| A4 | 1.0 | 15.0 | 39 | First | 1,700 | 20 | 30 | Comparative |
| | | | | Second | 700 | | | example |
| A5 | 0.30 | 3.5 | 25 | First | 1,200 | 20 | 100 | This invention |
| | | | | Second | 700 | | | |
| A6 | 1.0 | 5.5 | 34 | First | 1,200 | 120 | 90 | This invention |
| | | | | Second | 700 | | | |
| A7 | 1.5 | 10.0 | 25 | First | 1,200 | 60 | 150 | This invention |
| | | | | Second | 700 | | | |
| A8 | 1.0 | 1.0 | 18 | First | 700 | Not used | 100 | This invention |
| | | | | Second | none | | | |
| B1 | — | 10.0 | 35 | First | 1,200 | 20 | 20 | Comparative |
| | | | | Second | 700 | | | example |
| B2 | — | 15.0 | 38 | First | 1,200 | 30 | 30 | Comparative |
| | | | | Second | 700 | | | example |
| B3 | — | 7.0 | 37 | First | 1,050 | 30 | 20 | Comparative |
| | | | | Second | 700 | | | example |

Note:
*An average sphere equivalent diameter of primary particles
“—” means that no liquid phase method was applied.

The particle sizes in Table 1 each means an average sphere equivalent diameter. As is apparent from Table 1, it was confirmed that the devices in which the particles of the present invention were used are excellent in luminance property.

### Example 2

Devices were prepared in the same manner as in Example 1, except for changing the size of the device to 1 meter square. As a result, it was confirmed that the devices of the present invention are thin and lightweight, and have such an excellent flexibility that the devices can be bent, and in addition the devices of the present invention that are high in luminous efficiency are able to uniformly emit a light with high luminance while the emission is not accompanied by heat generation.

Having described our invention as related to the present embodiments, it is our intention that the invention not be limited by any of the details of the description, unless otherwise specified, but rather be construed broadly within its spirit and scope as set out in the accompanying claims.

1. A semiconductor particle, which is formed by baking, at a temperature of from 500° C. to 1,500° C., a particle formed by a liquid phase method and having an average equivalent sphere diameter of primary particle of 0.15 μm or more.

2. The semiconductor particle according to claim 1, wherein, during the baking step, a mixture of the particle acting as a seed particle, formed by the liquid phase method, and a raw particle having an average equivalent sphere diameter of primary particle of 0.10 μm or less, is baked, to grow said seed particle.

3. The semiconductor particle according to claim 1, wherein the particle is formed, by dividing the baking step into a first baking and a second baking, in which the second baking is carried out at a temperature lower than the first baking.

4. The semiconductor particle according to claim 1, wherein said semiconductor is a II-VI group or III-V group compound.

5. The semiconductor particle according to claim 1, wherein said semiconductor is zinc sulfide.

6. The semiconductor particle according to claim 1, wherein a coefficient of deviation of the formed particle is 30% or less, in terms of equivalent sphere diameter.

7. A phosphor particle, containing, as a base material, a semiconductor particle, said semiconductor particle being formed by baking, at a temperature of from 500° C. to 1,500° C., a particle formed by a liquid phase method and having an average equivalent sphere diameter of primary particle of 0.15 μm or more.

8. The phosphor particle according to claim 7, wherein, during the baking step, a mixture of the particle acting as a seed particle, formed by the liquid phase method, and a raw particle having an average equivalent sphere diameter of primary particle of 0.10 μm or less, is baked, to grow said seed particle.

9. The phosphor particle according to claim 7, wherein the semiconductor particle is formed, by dividing the baking step into a first baking and a second baking, in which the second baking is carried out at a temperature lower than the first baking.

10. The phosphor particle according to claim 7, wherein a coefficient of deviation of the formed semiconductor particle is 30% or less, in terms of equivalent sphere diameter.

11. An electroluminescent device, comprising:
a light-emitting layer containing a phosphor particle;
a dielectric layer; and
a pair of electrodes sandwiching said light-emitting layer and said dielectric layer between the electrodes,
said phosphor particle containing, as a base material, a semiconductor particle, said semiconductor particle being formed by baking, at a temperature of from 500° C. to 1,500° C., a particle formed by a liquid phase method and having an average equivalent sphere diameter of primary particle of 0.15 μm or more.

12. The electroluminescent device according to claim 11, wherein, during the baking step, a mixture of the particle acting as a seed particle, formed by the liquid phase method, and a raw particle having an average equivalent sphere diameter of primary particle of 0.10 μm or less, is baked, to grow said seed particle.

13. The electroluminescent device according to claim 11, wherein the semiconductor particle is formed, by dividing the baking step into a first baking and a second baking, in which the second baking is carried out at a temperature lower than the first baking.

14. The electroluminescent device according to claim 11, wherein a coefficient of deviation of the formed semiconductor particle is 30% or less, in terms of equivalent sphere diameter.
